(19) United States
(12) Patent Application Publication
(10) Pub. No.: US 2022/0383227 A1
(43) Pub. Date: Dec. 1, 2022

(54) A Method for Generating a Performance Value of a Process Module and a System Thereof

(71) Applicant: Auk Industries Pte. Ltd., Singapore (SG)

(72) Inventors: Samuel Hua Feng Tan, Singapore (SG); Joseph Yue Hao Lum, Singapore (SG); Han Sheng Quek, Singapore (SG); Keyang Chen, Singapore (SG); Eu Harn Lee, Singapore (SG)

(21) Appl. No.: 17/770,710

(22) PCT Filed: Oct. 20, 2020
(86) PCT No.: PCT/SG20/50600

§ 371 Date: Apr. 21, 2022

(30) Foreign Application Priority Data
Oct. 21, 2019 (SG) 10201909817Q

(51) Int. Cl. G06Q 10/06; G06Q 50/04

(52) U.S. Cl. CPC G06Q 10/06393; G06Q 50/04

(57) ABSTRACT

The present invention provides to a system and a method for generating a performance value of a process module, such that the process module includes a plurality of sub-process modules, such that the process module is categorised into a category of a plurality of categories. The method includes retrieving a performance value for each of the plurality of sub-process modules, retrieving the category of the process module, generating the performance value of the process module based on the category of the process module, such that the performance value of the process module is generated from the performance values of the plurality of sub-process modules. Further, the present invention relates to a system and a method for identifying at least one bottleneck in a process module.

### CROSS-REFERENCE TO RELATED APPLICATION

The present application claims the benefit of Singapore Patent Application No. 10201909817Q filed on Oct. 21, 2019, which is incorporated by reference herein.

### TECHNICAL FIELD

The present invention relates to a system for generating a performance value of a process module comprising a plurality of sub-process modules. The present invention further relates to a method thereof. The present invention further relates to a system and method for identifying at least one bottleneck in a process module.

### BACKGROUND

The trend of mechanization and increasing complexity of manufacturing processes have created a growing need for data analytics and decision support tools to measure and improve the effectiveness of modern manufacturing plants.

Overall Equipment Effectiveness (OEE) is a generally used key performance indicator (KPI) in industrial production processes to quantify the effectiveness of the equipment. OEE is calculated by multiplying three independent values: Availability, Performance, and Quality. OEE is a measure comparing how well manufacturing equipment is running compared to the set targets or maximum potential output.

FIG. 1 shows a general illustration of a method for calculating the Overall Equipment Effectiveness (OEE). FIG. 1 illustrates a prior art method 10 for calculating the Overall Equipment Effectiveness (OEE). Overall Equipment Effectiveness [1] is obtained as a product of availability factor [2], performance factor [3] and quality factor [4], OEE [1]=Availability [2]×Performance [3]×Quality [4].

Total calendar time is the total amount of time theoretically available for equipment operation, i.e. 24 hours per day, 7 days per week. Scheduled production time is total calendar time less loading losses. The loading factor indicates the percentage of the total calendar time scheduled for production.

Availability factor [2] is the ratio of gross operating time to scheduled production time, where gross operating time is scheduled production time less availability losses, e.g. breakdown, changeover and setup.

Performance factor [3] is the ratio of net operating time to gross operating time, where net operating time is gross operating time less performance losses which include minor stops and speed loss or the relation of the actual production speed compared to the nominal, budgeted, or target production speed. Speed loss implies that the machine is operating but not at its maximum speed.

Quality factor [4] is the ratio of effective operating time to net operating time, where effective operating time is net operating time less quality losses. Loss of quality occurs when the machine makes products that are not within the set acceptance limits and are rejected or require rework.

In typical current industrial practice, OEE is calculated individually for each single equipment through the use of data from existing systems i.e. measurement devices, automation systems, information systems, Manufacturing Execution Systems (MES), and other systems at industrial plants. A single fixed critical process or equipment or an average of multiple processes or equipment may be selected by the users, e.g. personnel of the operations function, to represent the effectiveness of a system that it is part of.

While the amount of data in a plant's existing systems' database is sometimes large, it is often not well organized for operations analyses and the information usability of the current systems is poor. To calculate OEE for each equipment, plant-specific customized integration and configuration are required to manually map and integrate data from existing systems. Implementation typically require large amount of technical resources, possible infrastructure changes and may incur huge cost. Existing data such as sensor reading may also frequently be unavailable or inaccessible directly from the equipment control systems. Information systems, Manufacturing Execution Systems (MES), and other systems may be incomplete or not implemented in the plant.

OEE of a single equipment may have limited relevance for improving the effectiveness of a higher-level system, e.g. the whole manufacturing plant, unless synthesized and analysed as part of a collective whole i.e. at the line-level or plant-level. Modern manufacturing plant typically consists of multiple processes and corresponding equipment which may be interconnected, either directly or indirectly, and are interdependent. If a particular machine is not the bottleneck process or constraint of the higher-level system which it is part of, improving the effectiveness of the particular machine will not make a material gain to the overall effectiveness of the higher-level system.

For line-level/plant-level performance, existing literature has recommended calculating the average effectiveness for a group of equipment. However, in many cases it may not reflect the system-level effectiveness accurately or fully due to the different dependencies equipment have on each other. In an example of a production line, where outputs of each process become inputs of the following downstream process, the overall line effectiveness will be zero (0%) if one critical equipment has broken down completely with zero output, regardless of whether other upstream processes is producing at full capacity (100%). The impact on effectiveness is different for a group of machines producing the same product in parallel. A manufacturing plant often comprises multiple levels of nested sub-processes and mixed dependencies.

Current available technology and methods of calculating performance value like OEE and other operational metrics target singular machines and is not able to fully represent the system level of a process using standard practices. Hence, it is not able to dynamically identify bottlenecks. As a result, users may not focus improvement work on the top priority process, and result in waste of resources that does not produce the desired increase in overall effectiveness.

It is thus an objective of the present invention to provide a universal, quick and easy solution to resolve the abovementioned issues.

### SUMMARY

According to various embodiments, the present invention provides to a method for generating a performance value of a process module, such that the process module includes a plurality of sub-process modules, such that the process module is categorised into a category of a plurality of categories. The method includes retrieving a performance value for each of the plurality of sub-process modules, retrieving the category of the process module, generating the performance value of the process module based on the category of the process module, such that the performance value of the process module is generated from the performance values of the plurality of sub-process modules.

According to various embodiments, such that generating the performance value of the process module may include generating an average performance value of the performance values of the plurality of sub-process modules and assigning the average performance value to the performance value of the process module.

According to various embodiments, such that generating the performance value of the process module may include determining a critical performance value of the performance values of the plurality of sub-process modules and assigning the critical performance value to the performance value of the process module.

According to various embodiments, the critical performance value of the sub-process modules may be generated based on the longest cycle time of one of the plurality of sub-process modules, the highest performance indicator percentage among the plurality of sub-process modules, or one of the plurality of sub-process modules selected by a user.

According to various embodiments, the plurality of categories may include a combinatory process module such that the output of the plurality of sub-process modules are combined, a sequential process module such that the plurality of sub-process modules are arranged in sequence and an alternate process module such that the plurality of sub-process modules are run parallel to each other.

According to various embodiments, such that, when the alternative process module is determined, the average performance value of the performance values of the plurality of sub-process modules may be assigned to the performance value of the process module.

According to various embodiments, such that, when, the combinatory process module or the sequential process module is determined, the critical performance value of the performance values of the plurality of sub-process modules may be assigned to the performance value of the process module.

According to various embodiments, the method may further include receiving input data from the plurality of sub-process modules, such that the performance value for each of the plurality of sub-process modules is generated based on the input data.

According to various embodiments, the performance value may include at least one of Overall Equipment Effectiveness (OEE) and Key Performance Index (KPI).

According to various embodiments, the present invention provides to a system for generating a performance value of a process module having a plurality of sub-process modules, such that the process module is categorised into a category of a plurality of categories. The system includes a processor, a memory in communication with the processor for storing instruction executable by the processor, such that the processor is configured to retrieve a performance value for each of the plurality of sub-process modules, retrieve the category of the process module, and generate the performance value of the process module based on the category of the process module, such that the performance value of the process module is generated from the performance values of the plurality of sub-process modules.

According to various embodiments, such that, to generate the performance value of the process module, the processor may be configured to generate an average performance value of the performance values of the plurality of sub-process modules and assign the average performance value to the performance value of the process module.

According to various embodiments, such that, to generate the performance value of the process module, the processor may be configured to generate a critical performance value of the performance values of the plurality of sub-process modules and assign the critical performance value to the performance value of the process module.

According to various embodiments, the critical performance value of the sub-process modules may be generated based on the longest cycle time of one of the plurality of sub-process modules, the highest performance indicator percentage among the plurality of sub-process modules, or one of the plurality of sub-process modules selected by a user.

According to various embodiments, the plurality of categories may include a combinatory process module such that the output of the plurality of sub-process modules are combined, a sequential process module such that the plurality of sub-process modules are arranged in sequence and an alternate process module such that the plurality of sub-process modules are run parallel to each other.

According to various embodiments, such that, when the alternative process module is determined, the average performance value of the performance values of the plurality of sub-process modules may be assigned to the performance value of the process module.

According to various embodiments, such that when the combinatory process module or the sequential process module is determined, the critical performance value of the performance values of the plurality of sub-process modules may be assigned to the performance value of the process module.

According to various embodiments, the processor may further be configured to receive input data from the plurality of sub-process modules, such that the performance value for each of the plurality of sub-process modules may be determined based on the input data.

According to various embodiments, the performance value may include at least one of Overall Equipment Effectiveness (OEE) and Key Performance Index (KPI).

According to various embodiments, the present invention provides a method for identifying at least one bottleneck in a process module. The method includes retrieving information of a process module or sub-process module, assigning the information to one of a plurality of process units, such that each of the plurality of process units represents a process module or a sub-process module, categorising each of the plurality of process units into one of a plurality of categories, such that the process module or sub-process module represented by the process unit is assigned the category of the process unit, generating a performance value of each of the plurality of process units using the method as described above, and identifying one or more of the plurality of process units that cause the bottleneck in the process module based on the performance value of each of the plurality of process units to detect the bottleneck in the process module.

According to various embodiments, the present invention provides a system for identifying at least one bottleneck in a process module. The system includes a processor, a memory in communication with the processor for storing instruction executable by the processor, such that the processor is configured to retrieve information of a process module or sub-process module, assign the information to one of a plurality of process units, such that each of the plurality of process units represents a process module or a sub-process module, categorise each of the plurality of process units into one of a plurality of categories, wherein the process module or sub-process module represented by the process unit is assigned the category of the process unit, generate a performance value of each of the plurality of process units using the method as described above, and identify one or more of the plurality of process units that cause the bottleneck in the process module based on the performance value of each of the plurality of process units to detect the bottleneck in the process module.

### BRIEF DESCRIPTION OF DRAWINGS

FIG. 1 shows a general illustration of a method for calculating the Overall Equipment Effectiveness (OEE).

FIG. 2 shows a flow diagram of an exemplary method for generating a performance value of a process module comprising a plurality of sub-process modules.

FIG. 3 shows an exemplary embodiment of a system for generating the performance value of the process module having the plurality of sub-process modules.

FIG. 4 shows an exemplary embodiment of the system in communication with the process module.

FIG. 5A shows an exemplary embodiment of the alternative process module.

FIG. 5B shows an exemplary embodiment of the combinatory process module.

FIG. 5C shows an exemplary embodiment of the sequential process module.

FIG. 6 shows an exemplary embodiment of a process module.

FIG. 7 shows a hierarchy tree diagram of the process module.

FIG. 8 shows a flow chart of a method for calculating the performance value for the process module as shown in the hierarchical tree diagram in FIG. 7.

FIG. 9 shows an exemplary embodiment of a real-time user interface of the system.

FIG. 10 shows an embodiment of the system interface for the system in FIG. 3.

FIG. 11 shows an exemplary flowchart of a method for identifying at least one bottleneck in a process module.

### DETAILED DESCRIPTION

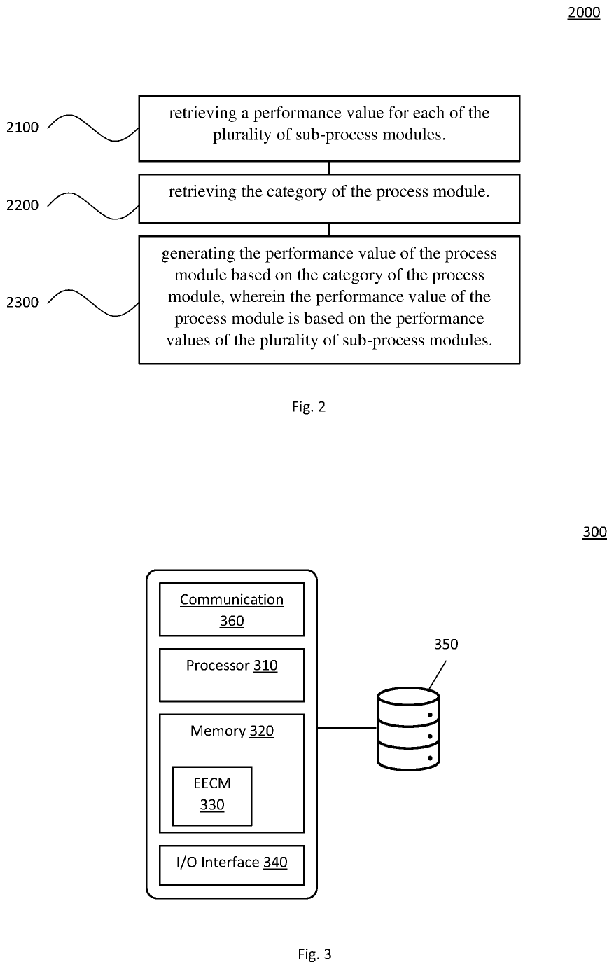

FIG. 2 shows a flow diagram of an exemplary method 2000 for generating a performance value of a process module having a plurality of sub-process modules. Process system is categorised into a category of a plurality of categories. Method 2000 includes retrieving a performance value for each of the plurality of sub-process modules in block 2100, retrieving the category of the process module in block 2200, and generating the performance value of the process module based on the category of the process module, such that the performance value of the process module is generated from the performance values of the plurality of sub-process modules in block 2300.

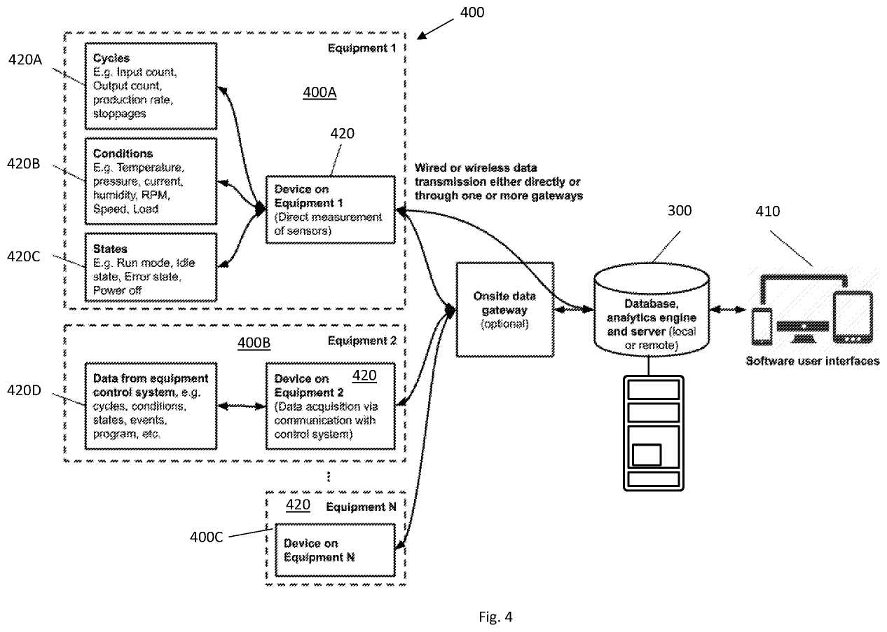

FIG. 3 shows an exemplary embodiment of a system 300 for generating the performance value of the process module having the plurality of sub-process modules. System 300 may include a server. System 300 includes a processor 310, a memory 320 in communication with the processor 310 for storing instruction executable by the processor 310, such that the processor 310 is configured to retrieve a performance value for each of the plurality of sub-process modules, retrieve the category of the process module, and generate the performance value of the process module based on the category of the process module, such that the performance value of the process module is generated from the performance values of the plurality of sub-process modules. Method 2000 may be a computer implemented method such that the system 300 may be configured to implement the method 2000. System 300 may include an I/O interface 340 configured to provide an interface between the processor 310 and peripheral interface modules, e.g. keyboard, mouse, etc. System 300 may include a communication module 360 configured to facilitate communication, wired or wirelessly, between the system 300 and other devices, e.g. measurement/data acquisition hardware devices. System 300 may include a database 350 configured to store input data, e.g. equipment cycle, state and/or condition data, received from the processor 310 from the sub-process modules and other data including category of the process module and sub-process modules, weightage, etc. Processor 310 may retrieve the performance value of each of the plurality of sub-process modules and the category of the process module from the database 350. System 300 may include an equipment effectiveness calculation module (EECM) loaded into the memory 320 and configured to calculate the performance value of the sub-process modules. EECM may generate the performance value of the process module based on the performance values of the sub-process modules.

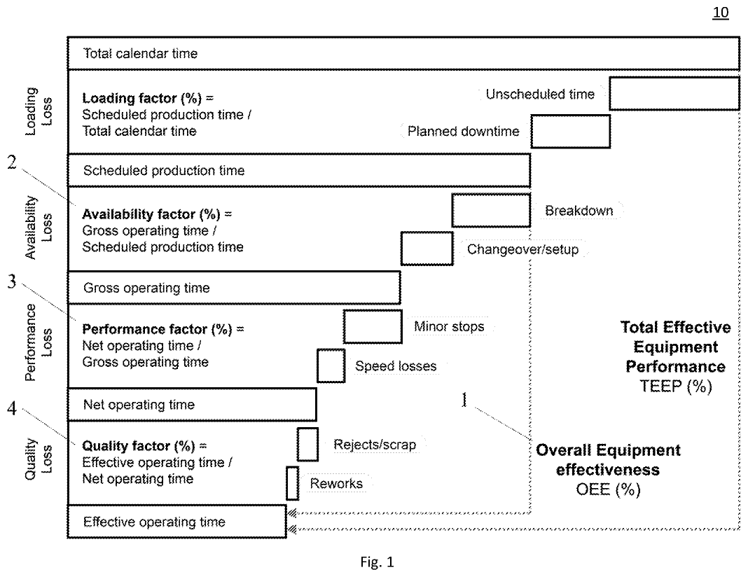

Process module may be a manufacturing process of a manufacturing plant, production process, etc. Process module may be part of the manufacturing process. Manufacturing process may include at least one process module. Process module may include one or more sub-process modules. Sub-process module may include an equipment, a system, machine units, etc., being part of the manufacturing process. System 300 may be configured to obtain input data, e.g. equipment cycle, state and/or condition data, from the sub-process modules. The input data may be received continuously and stored in the database 350. Input data may be retrieved from the database 350 and the performance value of the sub-process modules may be calculated by the EECM. Performance values of the sub-process modules may be calculated based on the equipment cycle, state and/or condition data, e.g. as shown in FIG. 1. Performance value of the process module may be calculated by the processor 310 as an aggregate of the performance values of the sub-process modules. Performance value may include at least one of Overall Equipment Effectiveness (OEE) and Key Performance Index (KPI).

Method 2000 and system 300 may be suitable for improving the effectiveness of the process module in, for example, a manufacturing process, and help industrial plants to improve their productivity. Method 2000 and the system 300 are capable of aiding operations, engineering and maintenance organizations in industrial plants in their decision making. The improvement of the performance value can have a major impact on profitability of the production plant by increasing capacity, productivity and reducing operating costs, and avoid unplanned shutdowns, speed losses, stoppages and defects. Method 2000 and the system 300 may be applicable to various industrial processes and plants, e.g. metal manufacturing, plastic manufacturing, chemical manufacturing, food and beverage manufacturing, automotive manufacturing and general manufacturing. Method 2000 and the system 300 are configured to synthesize information from lower-levels process systems and equipment to accurately determine system performance, as well as identification of system bottlenecks either statically or dynamically, so as to support users to focus improvement resources appropriately.

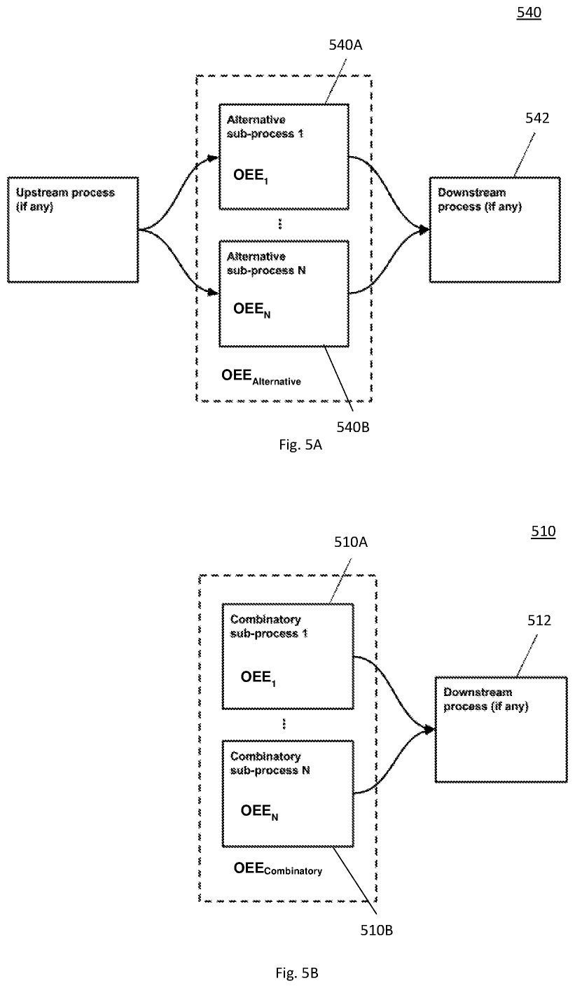

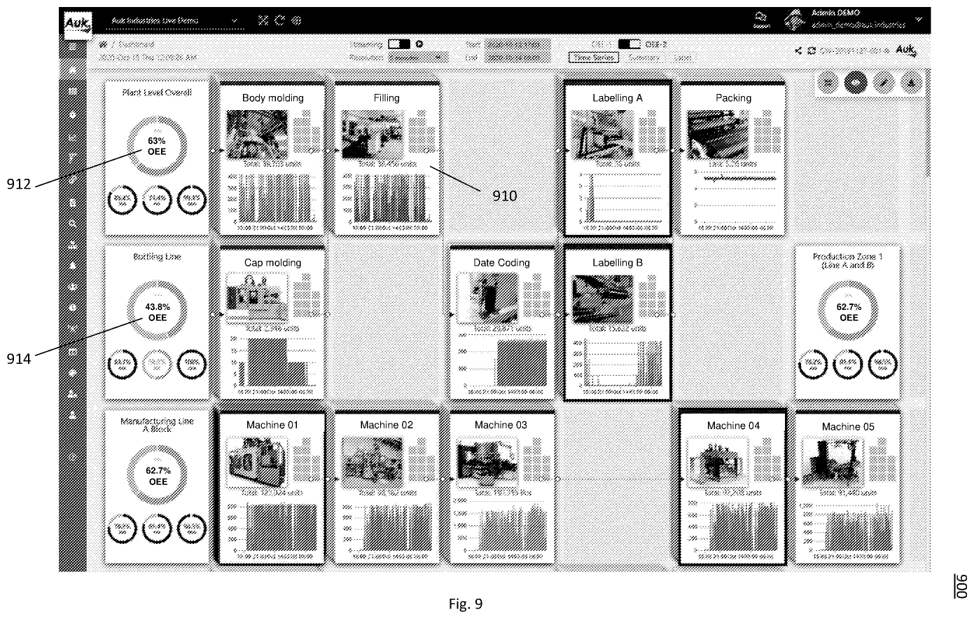

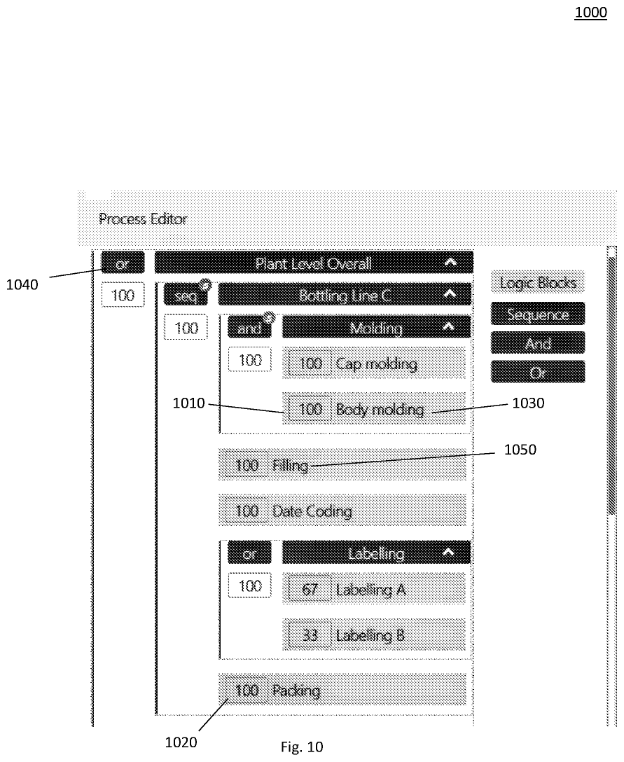

FIG. 4 shows an exemplary embodiment of the system 300 in communication with the process module 400. System 300 may be configured to communicate with the process module 400 via wire or wireless transmission. Process module 400 may include a plurality of measurement/data acquisition hardware devices, e.g. sensors, gauges, counters, configured to measure/acquire input data from the sub-process modules 400A, 400B, 400C. System 300 may be configured to communicate with a user device 410, e.g. mobile phone, tablet, computer, which may display a system interface for users. One or more hardware-based devices 420 may be implemented on each of the sub-process module 400A, 400B, 400C in order to either continuously measure input data, e.g. equipment cycle 420A, condition 420B and/or state 420C directly, or continuously acquire input data from existing equipment control systems 420D for each sub-process module 400A, 400B, 400C. System 300, via a software system interface, may allow the configuration of the system process diagram by the users, e.g. personnel of the operations function as shown in FIG. 9 and FIG. 10.

Process module 400 and sub-process modules 400A, 400B, 400C may be related to or interdependent on each other in a plurality of ways. System 300 may receive instructions via the system interface to define the interdependencies between process module 400 and sub-process modules 400A, 400B, 400C which may include one or more equipment. Process module 400 may be categorised into a plurality of categories. The categorization of the process module 400 is based on the interdependencies between the process module 400 and sub-process modules 400A, 400B, 400C. Plurality of categories may include one or more of i) a combinatory process module such that the output of the plurality of sub-process modules are combined, ii) a sequential process module such that the plurality of sub-process modules are arranged in sequence, iii) an alternate process module such that the plurality of sub-process modules are run parallel to each other and iv) nil process module such that the process module has no sub-process module. The connection or relationship between the process module 400 and the sub-process modules 400A, 400B, 400C may be defined using one of three abovementioned categories or process connection types. Multiple levels of nested sub-process modules in process module may be defined as will be shown below. In a multiple level process module, a sub-process module with its sub-process modules may be assigned as a process module. In other words, a process module may be a parent module with its child modules. Depending on the relationship between the process module and the sub-process module, the user may define the category of the relationship and assign it to the process module 400 in the system 300. If the sub-process module 400A, 400B, 400C is a parent module to its sub-process modules, the category of their relationship may also be defined for the sub-process module 400A, 400B 400C. Category of the process module 400 or sub-process modules 400A, 400B, 400C may also be stored in the database 350. System 300 may be configured to calculate the performance value, e.g. system effectiveness value, of each sub-process module 400A, 400B, 400C based on the input data, e.g. equipment cycles, conditions, states, event category labels by users and/or equipment log where available. Thereafter, the system 300 may calculate the performance value via the equipment effectiveness calculation module (EECM) based on the category of the process module 400 as will be explained below.

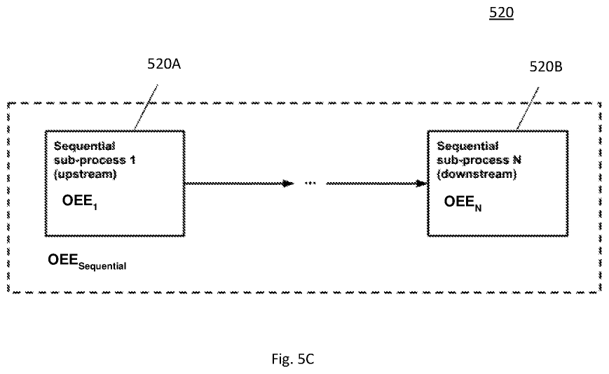

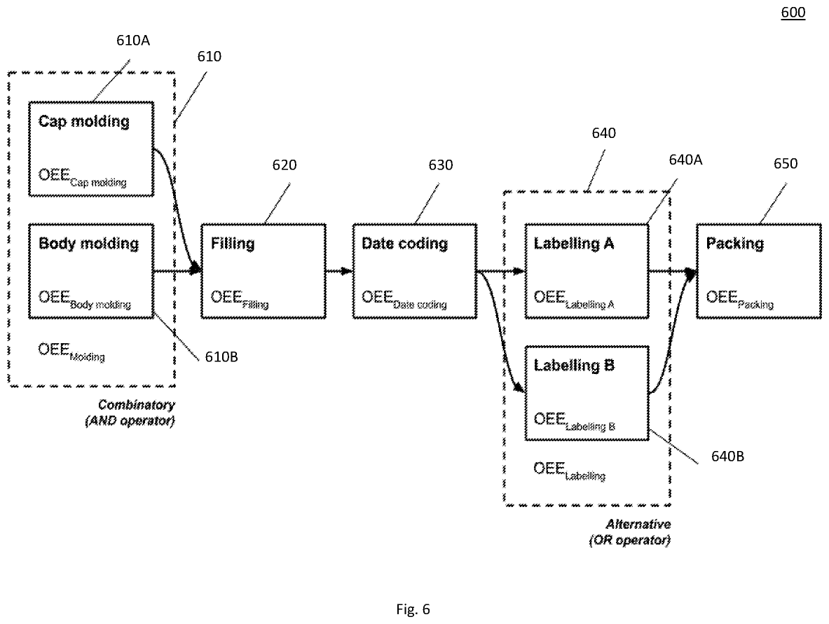

FIG. 5A shows an exemplary embodiment of the alternative process module 540. Alternative sub-process module may include two or more sub-process modules 540A,540B which may produce output without dependencies on each other. Sub-process modules 540A,540B may be parallel processes which produce the same product or partially finished product that becomes input material for following downstream sub-process module 542, if any. Sub-process modules 540A,540B may include possibly parallel processes producing different finished products of the same or different economic values. For example, an “Or” logic operator may be used to connect sub-process modules 540A,540B. An example of alternative process module 540 may be shown in FIG. 6, wherein the labelling process module 640 of a beverage bottling plant may include a multiple of sub-process modules, e.g. a first labelling sub-process module 640A and a second labelling sub-process module 640B, in parallel.

FIG. 5B shows an exemplary embodiment of the combinatory process module 510. Combinatory process module 510 may include two or more parallel sub-process modules 510A,510B which produces different products or partially finished products that are used to complement each other in a fixed or dynamic ratio in the following downstream sub-process module 512, if any. For example, an “And” logic operator may be used to connect the sub-process modules 510A,510B. An example of the combinatory process module 510 may be shown in FIG. 6, wherein the beverage bottling plant may include the sub-process module 610A for bottle cap molding and the sub-process module 610B for bottle body molding arranged in parallel to produce the beverage bottle.

FIG. 5C shows an exemplary embodiment of the sequential process module 520. Sequential sub-process module may include two or more serial sub-process modules 520A,520B of which the output product or partially finished products of an upstream sub-process module 520A becomes the input material of the following downstream sub-process module 520B. For example, a “Seq” logic operator may be used to connect the sub-process modules 520A,520B. An example of sequential processes may be shown in FIG. 6, wherein the beverage bottling plant includes the sequential sub-process modules of bottle filling 620, followed by bottle date coding 630, etc.

FIG. 6 shows an exemplary embodiment of a process module 600. Process module 600 may be a manufacturing plant, e.g. a beverage bottling plant. As shown in FIG. 6, the bottling plant may include the following sub-process modules, molding sub-process module 610, filling sub-process module 620, date coding sub-process module 630, labelling sub-process module 640, and packing sub-process module 650. As mentioned, a sub-process module may be a process module if it has its sub-process modules. Hence, the term “process module” and “sub-process module” may be used interchangeably depending on the role of the module or their inter-relationship. For example, the molding sub-process module 610 may be known as the molding process module 610 when referring to its sub-process modules 610A,610B. Molding process module 610 may be a combinatory process module 510, wherein the molding process module 610 may include a cap molding sub-process module 610A and a body molding sub-process module 610B. The output of the sub-process modules 610A,610B, i.e. caps and bottles, may become the input material for the next sequential filling process module 620. Filling process module 620 upon receiving the input material fills the bottle and outputs the beverage bottles, which may become the input material for the next sequential date coding process module 630. Date coding process module 630 upon receiving the input material dates the beverage bottles and outputs the dated beverage bottles, which may become the input material for the next sequential labelling process module 640. Labelling process module 640 may be an alternative process module 540, wherein the labelling process module 640 may include a first labelling sub-process module 640A and a second labelling sub-process module 640B. First labelling sub-process module 640A and the second labelling sub-process module 640B may be two equipment that performs the same task of labelling the dated beverage bottles. Labelling process module 640 may output the labelled beverage bottles, which may become the input material to the next sequential packing process module 650, which packs the labelled beverage bottles. System 300 may be configured to receive input data from the plurality of sub-process modules and generate the performance value of each of the sub-process modules 610,610A,610B,620,630,640,640A,640B,650 based on the input data. Thereafter, the system 300 may generate the performance value for the process module 600 from the performance values of the sub-process modules 610,610A,610B,620,630,640,640A,640B,650 based on the category of the process module 600.

System 300 may be configured to identify at least one bottleneck in the process module 600. For a combinatory process module 510, e.g. the molding process module 610, the performance value of the molding process module 610 may be equivalent to the performance value of the bottleneck sub-process module. A bottleneck sub-process module may be identified either by (i) the longest cycle time, (ii) the highest OEE percentage given similar relative output quantity among sub-processes, or (iii) a manual selection by a user. A critical performance value may be determined based on the performance values of the plurality of sub-process modules. The critical performance value may be assigned to the performance value of the process module. In other words, the critical performance value of the sub-process modules may be generated based on the longest cycle time of one of the plurality of sub-process modules, the highest performance indicator percentage among the plurality of sub-process modules, or one of the plurality of sub-process modules selected by a user. Hence, the bottleneck sub-process module may have the critical performance value. In this example, assuming that the cap molding sub-process module 610A has a higher production capacity or shorter cycle time (time taken to produce one unit), the body molding sub-process module 610B may be identified as the bottleneck sub-process module within the molding process module 610, and therefore, the performance value of the molding process module 610 may be determined to be the critical performance value and may be equivalent to the performance value of the body molding sub-process module 610B. In the same example, assuming that the filling sub-process module 620 has the longest cycle time and is identified as the bottleneck sub-process, then the performance value of the process module 600 may be determined as the critical performance value and may be equivalent to the performance value of the filling sub-process module 620. The cycle time of each sub-process module may be measured continuously using measurement devices, data acquisition system or other information systems, and correspondingly, the bottleneck sub-process module identified may be changed dynamically in real-time. For the labelling process module 640, which is made up of two alternative sub-process modules, the first labelling sub-process module 640A and the second labelling sub-process module 640B, which are two modules or equipment performing the same task of labelling the bottles, the performance value of the labelling process module 640 may be calculated as the average of the performance values of the first labelling sub-process module 640A and the second labelling sub-process module 640B. Once the performance values of the sub-process modules 610,620,630,640,650 are generated, the performance value of the process module 600, as it is a sequential process module, may be generated by generating the critical performance value of the plurality of sub-process modules 610,620,630,640,650 and assigning the critical performance value to the performance value of the process module 600.

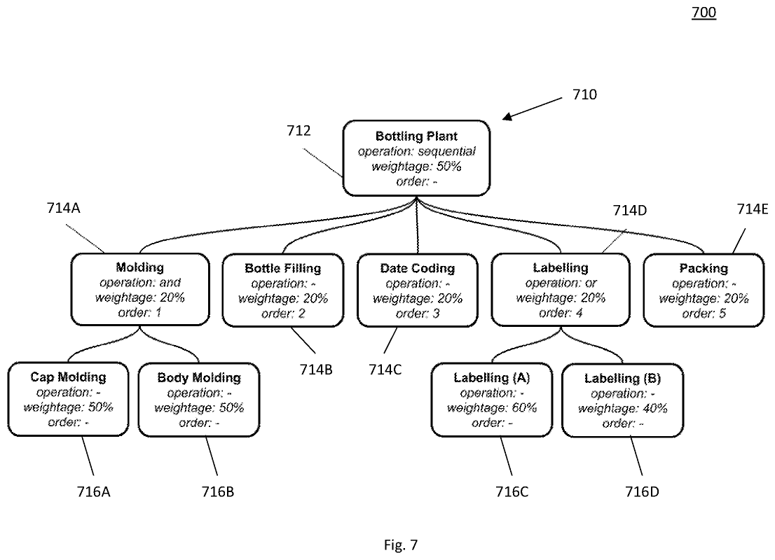

FIG. 7 shows a hierarchy tree diagram 700 of the process module 600. Hierarchy tree diagram may be another representation of the process module 600 for the generation of the performance value of the process module. As shown in FIG. 7, each process module or sub-process module in FIG. 6 may be represented as a node 710 in FIG. 7. A parent node 712 may be a node 710 that branches out one or more child nodes 714A,714B,714C,714D,714E. A leaf node may be a node 710 that is at the end of the tree diagram, e.g. a child node with no child node. Similar to the plurality of categories, there are types of node connection operators to determine how the child node is related or connected to a parent node. Types of node operators may include sequential (“seq”) operator which represents sub-process modules that are sequentially ordered; combinatory (“and”) operator may represent sub-process modules that are combinatory; alternative (“or”) operator may represent sub-process modules that are alternative to each other. Referring to FIG. 7, a node 712 may include at least one of a process module title, e.g. “bottling plant”; a node operator, e.g. “sequential”; a weightage, e.g. “50%”, and an order, e.g. “-”. Weightage may be manually or automatically input for weighing the relative production capacity or economic value of output for each child node within a parent node. “Order” may be the sequence the child nodes, i.e. the sequential sub-process modules, are related or connected to the parent node. Node 714A may be a child node to node 712 and a parent node to node 716. Node 714B may be a leaf node. Node 712, being the top node, may be a root node. Nodes 714A,714B,714C,714D,714E may be the child nodes of node 712. At the same time, node 714A may be the parent node of child nodes 716A,716B and node 714D may be the parent node of child nodes 716C,716D. As explained earlier, with reference to the process module 600 in FIG. 6, a sub-process module which has a sub-process module may be a process module. Beverage bottling plant may be the process module 600 such that the molding process module 610, bottle filling process module 620, date coding process module 630, labelling process module 640, and packing process module 650 may be its sub-process modules. Molding process module 610 may include cap molding sub-process module 610A and body molding sub-process module 610B. Labelling process module 640 may include the first labelling sub-process module 640A and the second labelling sub-process module 640B. As mentioned earlier, the process module 600 may be represented by one or more levels. For example, referring to FIG. 7, the process module 600 may include three levels, a first level or top level, e.g. beverage bottling plant node 712, a second level or an intermediate level, e.g. molding node 714A, a third level or bottom level, e.g. cap molding node 716A.

Using the hierarchy tree diagram 700 in FIG. 7, to calculate the performance value for the process module 600, e.g. the whole bottling plant, the performance value is first calculated for each individual sub-process modules 610,620,630,640,650, which is represented by the respective nodes and the performance values of the sub-process modules 610,620,630,640,650 may be aggregated and assigned to the performance value of the process module 600 denoted by node 712. Performance value of each sub-process module 610,620,630,640,650 may be calculated based on at least one of availability factor, performance factor and quality factor. Availability factor may be based on data like malfunctions, unplanned idle time and operational data like on/off status, etc. Performance factor may include data based on cycle time, production rate (units/hour) and minor stoppages (frequency and duration), etc. Quality factor may include data based on liquid fill height, weight, leakages, Brix (sugar content) level, etc. If the node of a process module is one of a combinatory process module 510 or a sequential process module 520, a critical performance value of the performance values of the plurality of sub-process modules 510A,510B,520A,520B may be determined and the critical performance value may be assigned to the performance value of the process module 600. A critical performance value may be the performance value of a bottleneck sub-process module. The critical performance value of the sub-process modules may be generated based on the longest cycle time of one of the plurality of sub-process modules, the highest performance indicator percentage among the plurality of sub-process modules, or one of the plurality of sub-process modules selected by a user. If the node of the process module 600 is an alternative process module 540, an average performance value of the performance values of the plurality of sub-process modules 540A,540B may be generated and the average performance value may be assigned to the performance value of the process module 600. Performance values may be weighted by relative production capacity or economic value of output of each sub-process module. In this example, the node 716C representing the first labelling sub-process module 640A may have a 50% higher production capacity than node 716D representing the second labelling sub-process module 640B. Hence, the weightage ratio may be 3:2 or 60:40, and therefore, the performance value of the labelling process module 640 may be expressed as: the performance value of the first labelling sub-process module 640A×60%+the performance value of the second labelling sub-process module 640B×40%.

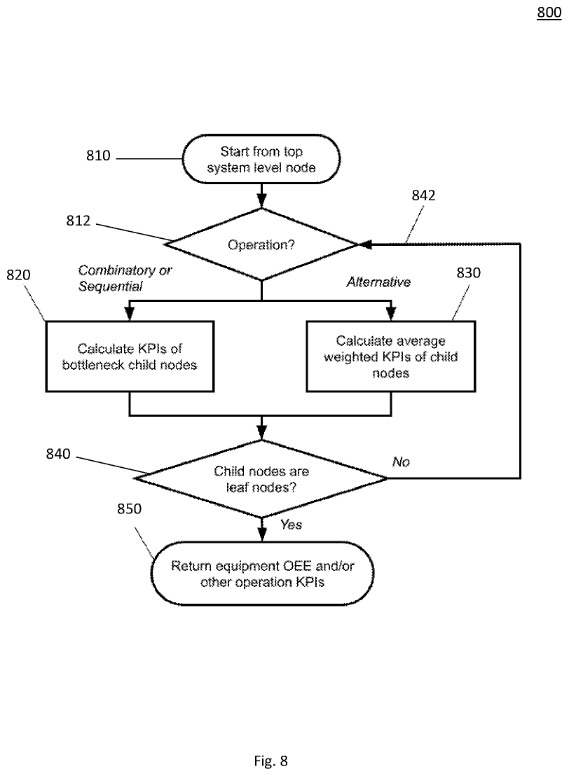

FIG. 8 shows a flow chart of an exemplary method 800 for calculating the performance value for the process module 600 as shown in the hierarchical tree diagram in FIG. 7. Method 800 may be part of method 2000. As mentioned, the method 800 may include retrieving the performance values of the plurality of sub-process modules 610,620,630,640,650 identified by the child nodes 714A,714B,714C,714D,714E. Referring to FIG. 8, the method 800 may be initiated at block 810 and may include retrieving the category of a parent node, e.g. the beverage bottling plant node 712 in FIG. 7 from the database 350. In block 812, the method 800 may include determining the operation required by the category of the parent node 712. Based on the category of the parent node 712, the performance values of its child nodes 714A,714B,714C,714D,714E may be aggregated. If the parent node is a combinatory process module 510 or a sequential process module 520, the method 800 may include calculating the performance value of the bottleneck child node, i.e. determining the critical performance value of the performance values of the plurality of sub-process modules 610,620,630,640,650 denoted by the child nodes 714A,714B,714C,714D,714E, at block 820. The critical performance value may be due to a bottleneck sub-process module denoted by its child node. If the parent node, e.g. 714D, is an alternative process module 540, the method 800 may include calculating the average performance value of the plurality of sub-process modules 540A,540B, i.e. generating an average performance value of the performance values of the plurality of sub-process modules denoted by its child nodes 716C,716D, at block 830. Performance value of the sub-process module may be weighted by relative capacity or nominal/target output value of each child-process. Method 800 may include factoring the weightage assigned to the child node before assigning the performance value to the parent node. The cycle time and performance value of each sub-process module may be measured and calculated continuously using measurement devices, data acquisition system or other information systems, and correspondingly, the bottleneck sub-process module identified may change dynamically in real-time.

Method 800 may include determining whether the child node is a leaf node at block 840. If the child node, e.g. 716A, is a leaf node, the method 800 may include aggregating the performance value of the child node up the hierarchy level at block 850. When the sub-process module is denoted by a leaf node, the data of sub-process module may be collected, and performance value can be derived. If the child nodes are not leaf nodes, i.e. the child nodes are intermediate child nodes with their own child nodes, the method 800 may repeat the operation repeatedly for the child nodes based on their associated category (as described above) until the child node is a leaf node. Method 800 may be carried out recursively until the performance values are aggregated to the highest level.

FIG. 9 shows an exemplary embodiment of a real-time user interface 900 of the system 300. User interface 900 is configured for users to view current and past performance values and enables the users to view the performance values of the sub-process modules. Each of the process module 600 and sub-process module 610,620,630,640,650,610A,610B,640A,640B may be represented by an icon of a process unit 910. Each process unit represents a process module 600 or a sub-process module 610,610A,610B,620,630,640,640A,640B,650. System 300 may be configured to allow users to define and configure the relations and interdependence of processes and sub-processes within a manufacturing plant to enable continuous, near real-time and static or dynamic system level analytics and performance value, e.g. OEE, calculation and generation. Each of the process unit may be categorised into one of the plurality of categories.

System 300 may be an identification system for identifying at least one bottleneck in the process module 600. System 300 may be configured to monitor the performance values of a plurality of process units 910 and detect the process unit 910 that causes the bottleneck in the process module 600. Process unit 910 may represent a process module 600 or a sub-process module 610,610A,610B,620,630,640,640A,640B,650. System 300 may be configured to retrieve information of the process module 600 or sub-process module 610,610A,610B,620,630,640,640A,640B,650 from the database 350 or directly from the process module 600 or plurality of sub-process modules 610,610A,610B,620,630,640,640A,640B,650 and assign the information to one of a plurality of process units. Information may include the identification, performance value, etc. such that the system 300 is configured to display the information of the process units 910 in the system interface as shown in FIG. 10. System 300 may be configured to categorise each of the plurality of the process units 910 into one of the plurality of categories such that the process module 600 or sub-process module 610,610A,610B,620,630,640,640A,640B,650 represented by the process unit 910 may be assigned the category of the process unit 910. System 300 may be configured to receive user input to categorise the plurality of process units 910. For example, the user may categorise the process unit 910 as a sequential process module if the plurality of sub-modules of the process module are arranged in sequence. The user may categorise plurality of the process units 910 as a combinatory process module if the output of its sub-process modules may be combined. The user may categorise plurality of the process units 910 as an alternative process module if its sub-process modules are running in a parallel arrangement to each other. Further, the system 300 may be configured to receive input on the order of the process units 910 with respect to each other. System 300 may be configured to receive input on the weightage of the sub-process modules 610,610A,610B,620,630,640,640A,640B,650. Once the process units 910 are identified, the system 300 may be configured to generate the performance value of the process module 600 using the method 2000 described above. As shown in FIG. 9, the user may be able to have an overview of the process module 600 and identify the bottleneck in the process module based on the user interface 900. For example, it is possible to identify the performance value of the process module 600 at 912, the performance value of a sub-process module at 914. Upon generating the performance value of the process module 600, the system 300 may be configured to identify the process unit 910 that causes the bottleneck based on the performance value of each of the process unit 910. To detect the process unit 910 that causes the bottleneck, the system 300 may be configured to detect the process unit 910 with the critical performance value and identify the bottleneck in the process module 600.

Depending on configuration of the process module 600, the system 300 may be customised to monitor and detect the process module 600 accordingly. The process module 600, e.g. a manufacturing process, may include unlimited permutations of process units 910. Hence, the system 300 may be configured to suit any one of the unlimited permutations of process units 910 in the process module 600. Once the categories of the process units 910 are identified, the system 300 would be able to detect the bottleneck in the process module 600.

FIG. 10 shows an embodiment of the system interface 1000 of the system 300. System interface 1000 may be used for users to define and visualize the process connections, order and/or weightage. Instead of visualizing the process connections using a hierarchy tree diagram as shown in FIG. 7, a multi-level sub-nested list 1010 may be used as the system interface for the users. System interface 1000 may allow users to drag and drop each process unit 910 in the desired order and nesting level, and also set or opt to automate the relative weightage or ratio 1020 for each sub-process module. As shown in FIG. 10, the system interface may receive at least one of the following inputs: identification of each process 1030; arrangement of the sequence of the processes 1050, e.g. order of the processes; and the relationship between two process module 1040, e.g. sequential, combinatory, alternative. System interface 1000 provides a graphical user interface of the process module 600 and a convenient and easy way of visualising, managing the modules. In this way, the system 300 allows an easy and efficient way of generating an accurate performance value of a process module 600 of a manufacturing process. Referring to FIG. 10, for example, the cap molding sub-process module 610A and body molding sub-process module 610B may be nested within the molding process module 610, which may be identified as a combinatory process module 510. The first labelling sub-process module 640A and the second labelling sub-process module 640B may be nested within the labelling process module 640, which may be identified as an alternative process module 540. Molding sub-process module 610, filling sub-process module 620, date coding sub-process module 630, labelling sub-process module 640 and packing process module 650 may be nested within the bottling line process module 600, which may be a sequential process module 520.

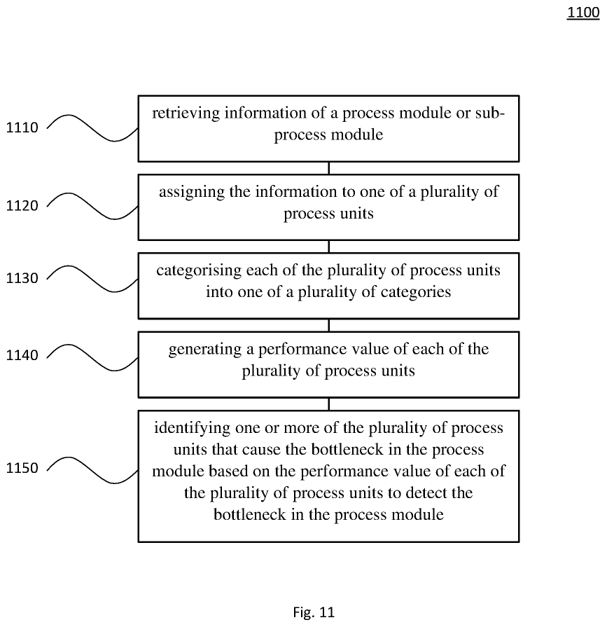

FIG. 11 shows an exemplary flowchart of a method 1100 for identifying at least one bottleneck in a process module 600. Method 1100 includes retrieving information of a process module 600 or sub-process module 610,610A,610B,620,630,640,640A,640B,650 in block 1110, assigning the information to one of a plurality of process units in block 1120, such that each of the plurality of process units represents a process module 600 or a sub-process module 610,610A,610B,620,630,640,640A,640B,650, categorising each of the plurality of process units into one of a plurality of categories in block 1130, such that the process module 600 or sub-process module 610,610A,610B,620,630,640,640A,640B,650 represented by the process unit is assigned the category of the process unit, generating a performance value of each of the plurality of process units using the method as described above in block 1140, and identifying one or more of the plurality of process units that cause the bottleneck in the process module 600 based on the performance value of each of the plurality of process units in block 1150 to detect the bottleneck in the process module 600. Method 1100 may be implemented by the system 300.

System 300 provides a system level performance value to be presented in easy to understand way to the users, i.e. plant operators and maintenance and automation personnel, i.e. operations personnel. A real-time display, e.g. real-time user interface 900, reveals the current and past trend of system level performance value, e.g. OEE, each sub-process performance value and other operational performance value e.g. KPIs. The relationship between each machine or sub-process may be shown on the interface. For example, a manufacturing line may include a plurality of machines/sub-processes and the manufacturing sequence of the machines/sub-processes are shown. The users of the system 300 can drill down to the system process diagram via the user interface 900 and see the source components of performance values, e.g. OEE and other operational KPIs, to find out the most significant reason for the decreased performance value. Based on this information, the users can make decisions for instance on what is the most important actions to take, i.e. improvement or maintenance tasks prioritization. The system interface 900 allows users to zoom in to sub-processes and explore computed metrics at each sub-process module of the system 300, so as to investigate into the root cause for the performance of the overall system. Users would then be able to pinpoint the exact cause for subpar performance of the overall system and take decisive action to focus resources in the right areas to increase overall effectiveness of the entire manufacturing plant.

The present invention is a simple but universal and powerful method to map out system level relationships between equipment/processes so that methods of computing important operational metrics at the singular machine level can be synthesized to arrive at the system/subsystem level for higher-order analysis for the purpose of improving overall manufacturing effectiveness.

A skilled person would appreciate that the features described in one example may not be restricted to that example and may be combined with any one of the other examples.

The present invention relates to a method and a system for generating a performance value of a process module and a system and a method for identifying at least one bottleneck in a process module generally as herein described, with reference to and/or illustrated in the accompanying drawings.

1. A method for generating a performance value of a process module,
wherein the process module comprises a plurality of sub-process modules, wherein the process module is categorized into a category of a plurality of categories, the method comprising:
retrieving a performance value for each of the plurality of sub-process modules,
retrieving the category of the process module,
generating the performance value of the process module based on the category of the process module, wherein the performance value of the process module is generated from the performance values of the plurality of sub-process modules.

2. The method according to claim 1, wherein generating the performance value of the process module comprises generating an average performance value of the performance values of the plurality of sub-process modules and assigning the average performance value to the performance value of the process module.

3. The method according to claim 1, wherein generating the performance value of the process module comprises determining a critical performance value of the performance values of the plurality of sub-process modules and assigning the critical performance value to the performance value of the process module.

4. The method according to claim 3, wherein the critical performance value of the sub-process modules is generated based on the longest cycle time of one of the plurality of sub-process modules, the highest performance indicator percentage among the plurality of sub-process modules, or one of the plurality of sub-process modules selected by a user.

5. The method according to claim 1, wherein the plurality of categories comprises a combinatory process module wherein the output of the plurality of sub-process modules are combined, a sequential process module wherein the plurality of sub-process modules are arranged in sequence and an alternate process module wherein the plurality of sub-process modules are run parallel to each other.

6. The method according to claim 5, wherein, when the alternative process module is determined, the average performance value of the performance values of the plurality of sub-process modules is assigned to the performance value of the process module.

7. The method according to claim 5, wherein, when, the combinatory process module or the sequential process module is determined, the critical performance value of the performance values of the plurality of sub-process modules is assigned to the performance value of the process module.

8. The method according to claim 1, further comprising receiving input data from the plurality of sub-process modules, wherein the performance value for each of the plurality of sub-process modules is generated based on the input data.

9. The method according to claim 1, wherein the performance value comprises at least one of Overall Equipment Effectiveness (OEE) and Key Performance Index (KPI).

10. A system for generating a performance value of a process module comprising a plurality of sub-process modules, wherein the process module is categorized into a category of a plurality of categories, the system comprising:
a processor,
a memory in communication with the processor for storing instruction executable by the processor,
wherein the processor is configured to:
retrieve a performance value for each of the plurality of sub-process modules,
retrieve the category of the process module, and
generate the performance value of the process module based on the category of the process module, wherein the performance value of the process module is generated from the performance values of the plurality of sub-process modules.

11. The system according to claim 10, wherein, to generate the performance value of the process module, the processor is configured to generate an average performance value of the performance values of the plurality of sub-process modules and assign the average performance value to the performance value of the process module.

12. The system according to claim 10, wherein, to generate the performance value of the process module, the processor is configured to generate a critical performance value of the performance values of the plurality of sub-process modules and assign the critical performance value to the performance value of the process module.

13. The system according to claim 12, wherein the critical performance value of the sub-process modules is generated based on the longest cycle time of one of the plurality of sub-process modules, the highest performance indicator percentage among the plurality of sub-process modules, or one of the plurality of sub-process modules selected by a user.

14. The system according to claim 10, wherein the plurality of categories comprises a combinatory process module wherein the output of the plurality of sub-process modules are combined, a sequential process module wherein the plurality of sub-process modules are arranged in sequence and an alternate process module wherein the plurality of sub-process modules are run parallel to each other.

15. The system according to claim 14, wherein, when the alternative process module is determined, the average performance value of the performance values of the plurality of sub-process modules is assigned to the performance value of the process module.

16. The system according to claim 14, wherein when the combinatory process module or the sequential process module is determined, the critical performance value of the performance values of the plurality of sub-process modules is assigned to the performance value of the process module.

17. The system according to claim 10, wherein the processor is further configured to receive input data from the plurality of sub-process modules, wherein the performance value for each of the plurality of sub-process modules is determined based on the input data.

18. The system according to claim 10, wherein the performance value comprises at least one of Overall Equipment Effectiveness (OEE) and Key Performance Index (KPI).

19. A method for identifying at least one bottleneck in a process module, the method comprising:
retrieving information of a process module or sub-process module,
assigning the information to one of a plurality of process units, wherein each of the plurality of process units represents a process module or a sub-process module,
categorizing each of the plurality of process units into one of a plurality of categories, wherein the process module or sub-process module represented by the process unit is assigned the category of the process unit,
generating a performance value of each of the plurality of process, and
identifying one or more of the plurality of process units that cause the bottleneck in the process module based on the performance value of each of the plurality of process units to detect the bottleneck in the process module.

20. A system for identifying at least one bottleneck in a process module, the system comprising:
a processor,
a memory in communication with the processor for storing instruction executable by the processor,
wherein the processor is configured to:
retrieve information of a process module or sub-process module,
assign the information to one of a plurality of process units, wherein each of the plurality of process units represents a process module or a sub-process module,
categorize each of the plurality of process units into one of a plurality of categories, wherein the process module or sub-process module represented by the process unit is assigned the category of the process unit,
generate a performance value of each of the plurality of process, and
identify one or more of the plurality of process units that cause the bottleneck in the process module based on the performance value of each of the plurality of process units to detect the bottleneck in the process module.
